(19) United States
(12) Patent Application Publication
(10) Pub. No.: US 2002/0085772 A1
(43) Pub. Date: Jul. 4, 2002

(54) Intelligent correction key

(75) Inventor: Joseph H. Lee, Foothill Ranch, CA (US)

Correspondence Address: LYON & LYON LLP, 633 WEST FIFTH STREET, SUITE 4700, LOS ANGELES, CA, 90071, US

(73) Assignee: Gateway, Inc.

(21) Appl. No.: 09/752,973

(22) Filed: Dec. 29, 2000

(51) Int. Cl. G06K 9/03

(52) U.S. Cl. 382/311

(57) ABSTRACT

A method is disclosed for automatically correcting an incorrectly recognized or converted character of text input onto a display screen of a computing device (e.g., a pen-based computer system such as a personal digital assistant) with a next most likely intended character upon actuation of a correction key. The next most likely intended character is preferably determined by ranking a plurality of potential intended characters, and then selecting a highest ranking character from the ranked plurality of potential intended characters as the next most likely intended character. The plurality of potential intended characters may be ranked based on statistical probabilities that one character will be incorrectly converted as another character, common sense that one character will be incorrectly converted as another character, and prior handwriting data choices collected for a user of the computing device.

### FIELD OF THE INVENTION

The present invention relates generally to software applications for correcting text input onto a display screen of a computing device, and in particular, to a software application for correcting an incorrectly recognized or converted character of text input onto the display screen of the computing device with a next most likely intended character upon actuation of a correction key.

### BACKGROUND OF THE INVENTION

Typically, personal digital assistants (PDAs) rely on the use of a stylus or a pen for data entry. A user moves the stylus across a pressure-sensitive surface of the PDA to form characters. PDAs use handwriting recognition software to interpret and convert the characters formed on the pressure-sensitive surface. Although handwriting recognition affords the user greater flexibility and speed in composing documents, it is prone to errors in handwriting conversion.

Because of variations in handwriting from one user to another user, even the most accurate handwriting recognition software may return incorrect results. Certain methods of correction involve the deletion and subsequent rewriting of the improperly recognized input. However, rewriting entire words is inefficient and time-consuming. Additionally, the rewritten input is not necessarily recognized more accurately with subsequent attempts.

To rectify this problem, some PDAs incorporate overwriting software, which allows the user to utilize the stylus and manually overwrite an incorrectly recognized character on the pressure-sensitive surface of the PDA. The overwriting software then attempts to determine the replacement character which the user has overwritten the incorrectly recognized character. While this technique may correct mistaken recognition of inputs, it is inefficient and often produces spurious results. Even after the user overwrites the incorrectly recognized character with a replacement character, the overwriting software may still incorrectly recognize the replacement character (possibly even as the same incorrectly recognized character), and thus, the user must continue to overwrite the incorrectly recognized character until it is correctly recognized by the overwriting software.

In addition to the aforementioned problems, prior art rewriting and overwriting techniques are flawed in that they require the users to exaggerate their natural handwriting styles in order to “trick” the handwriting recognition software. Many PDA users are forced to completely alter their own handwriting styles, which sacrifices both efficiency and convenience.

In view of the foregoing, a more effective and efficient method is needed for correcting characters on a display screen of a pen-based computer system.

### SUMMARY OF THE INVENTION

Accordingly, the present invention is directed to a method and a computing device for correcting a single character of text input onto a display screen of the computing device. One aspect of the present invention is directed to a method for automatically correcting an incorrectly recognized or converted character of text input onto a display screen of a computing device with a next most likely intended character upon actuation of a correction key.

A further aspect of the present invention is directed to determining the next most likely intended character by ranking a plurality of potential intended characters, and then selecting a highest-ranking character from the ranked plurality of potential intended characters as the next most likely intended character. The plurality of potential intended characters may be ranked based on statistical probabilities that one character will be incorrectly converted as another character, common sense that one character will be incorrectly converted as another character, and prior handwriting data choices collected for a user of the computing device.

The invention may include any one of these separate aspects individually, or any combination of these separate aspects. Other features and advantages of the invention will be evident from reading the following detailed description, which is intended to illustrate, but not limit, the invention.

### BRIEF DESCRIPTION OF THE DRAWINGS

FIG. 1 is a block diagram of a pen-based computer system in accordance with a preferred embodiment of the present invention.

FIG. 2 is a top plan view of the pen-based computer system shown in FIG. 1.

FIG. 3 is a flowchart illustrating a method for correcting a single character of text input onto a display screen of a computing device in accordance with a preferred embodiment of the present invention.

### DETAILED DESCRIPTION OF THE PREFERRED EMBODIMENTS

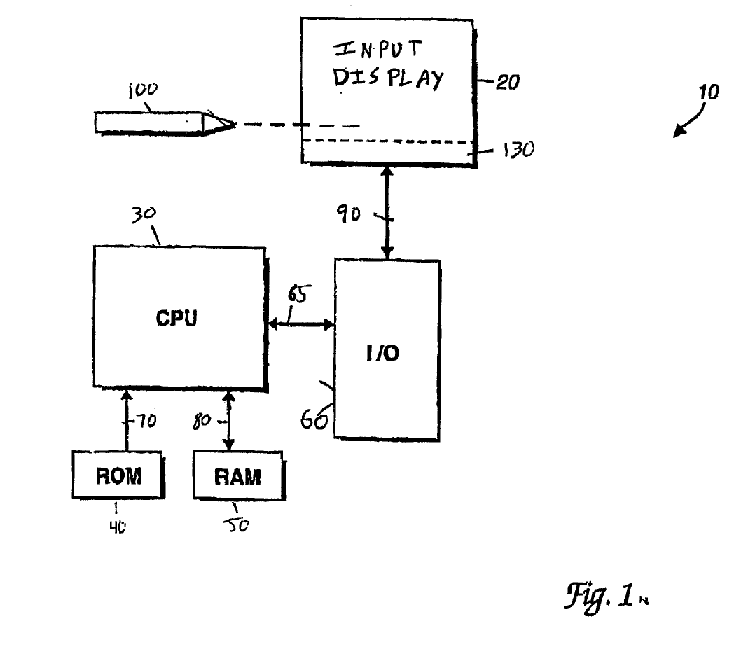

Referring to FIG. 1, a PDA system 10 in accordance with the present invention includes an input display system 20, a central processing unit (CPU) 30, a read only memory (ROM) 40, a random access memory (RAM) 50, and input/output (I/O) circuitry 60. The CPU 30 is coupled to the I/O circuitry 60 via a bidirectional data bus 65. The CPU 30 is also coupled to the ROM 40 via a unidirectional data bus 70, and is further coupled to the RAM 50 via a bidirectional data bus 80. The ROM 40 preferably stores the basic operating system for the PDA 10, as well as a software application for automatically correcting an incorrectly recognized or converted character with the next most likely intended character in accordance with a preferred embodiment of the present invention, as described in more detail below.

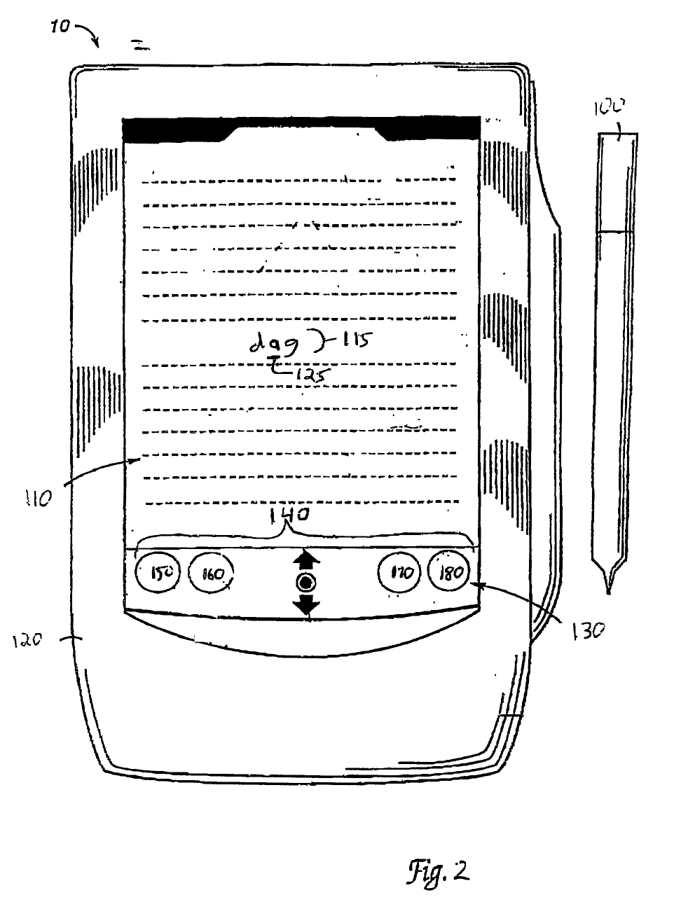

The input display system 20 is coupled to the I/O circuitry 60 via a bidirectional data bus 90 so that the display system 20 is capable of operating as a dual input and output device. As an input device, the display system 20 is capable of detecting the position of a stylus 100 on a suitable display screen, such as a liquid crystal display (LCD) 110, having a clear, thin membrane that is sensitive to the stylus 100, as shown in FIG. 2. As an output device, the display system 20 receives data from the I/O circuitry 60 via the data bus 90 and displays that data on the display screen 110. Input display systems having stylus-sensitive membranes are both well known in the art and readily available in the marketplace. Although the invention is described in connection with a PDA 10 having a stylus 100 as an input device, other types of computing devices (such as desktop computers, laptop computers, web appliances, and the like) as well as other types of input devices (such as a mouse, track ball, track stick, touch screen, touch pad, inductively coupled tablet, and the like) may also be utilized.

In use, data is input into the PDA 10 by handwriting on the display screen 110 with the stylus 100, and data concerning the location of the stylus 100 on display screen 110 is input into the CPU 30 via the data bus 90 and the I/O circuitry 60. This data includes the X-Y coordinates of a pixel of the display screen 110 over which the tip of the stylus 100 is positioned. The CPU 30 uses a software application to process and convert the data into text objects in a manner well known in the art. The text objects are then transferred to the display system 20 by the I/O circuitry 60 and the data bus 90 to produce corresponding images on the display screen 110.

Referring to FIG. 2, the PDA system 10 of FIG. 1 is partially enclosed within a housing 120 having a display screen 110 and a keypad 130 fully accessible to the user. The keypad 130 preferably comprises a row of soft keys 140 that may be actuated by a touch of the stylus 100 to the display screen 110 over the image of the desired key. The keypad 130 includes a correction key 150, which may alternatively be located at any other location on the display screen 110. The keypad 130 may further include an “accept change” key 160, a “next character” key 170, and an overwrite key 180. These keys, which are discussed in detail below, may alternatively appear as hard keys on a keyboard, icons or part of a pulldown menu on a display, or the like. Further, these keys may be actuated utilizing input devices other than the stylus 100, such as a keyboard, mouse, track ball, track stick, touch screen, touch pad, inductively coupled tablet, and the like.

In the embodiment illustrated in FIG. 2, a portion of the display screen 110 is shown in which a user's input of the word “dog” has been incorrectly converted to “dag” 115 by the PDA 10. To correct this mistake in accordance with the present invention, the user first touches the letter “a” 125 with the stylus 100. After selecting the letter “a” 125, the user touches the correction key 150 with the stylus 100, and the “a” 125 is automatically replaced with the next most likely intended character. As explained below, determination of the next most likely intended character may be based upon a number of factors, including the user's past tendencies, statistical analyses of typical handwriting conversion errors, and optional manual overwriting of the replacement character.

It is also understood that in an alternative embodiment, it may be preferable for a user to correct a character immediately upon realizing that the character has been mis-identified by the PDA. For example, the user inputs “d” and then “o”, but the PDA incorrectly assumes that the inputted “o” is an “a” and displays an “a”. At this point, the user may select the correction key 150, and during an initial “set-up” phase, the PDA will replace the “a” with the next most likely character and present a pop-up window asking whether the correct replacement letter has been selected. Then, after the “set-up” phase during which a history of the user's replacements are stored, the user can switch the PDA to a more automated mode whereupon the selection of the correction key 150 will automatically replace the last inputted letter with the most likely replacement letter without further prompting. Thus, as an example, in the more automated mode, the user inputs “d” and then “a”, and then realizes that the intended input of “o” has been misidentified as an “a”. The user selects the correction key 150, and the “a”, i.e., the last inputted letter, will automatically be converted to the user's historical “most likely replacement” for the letter “a”, which in this example would be the letter “o”. In this manner, the eventual use of the present invention allows for the user to input characters, and upon detecting a mis-identified character, to merely hit the correction key 150, and to automatically have the mis-identified character replaced with the user's most likely intended character input.

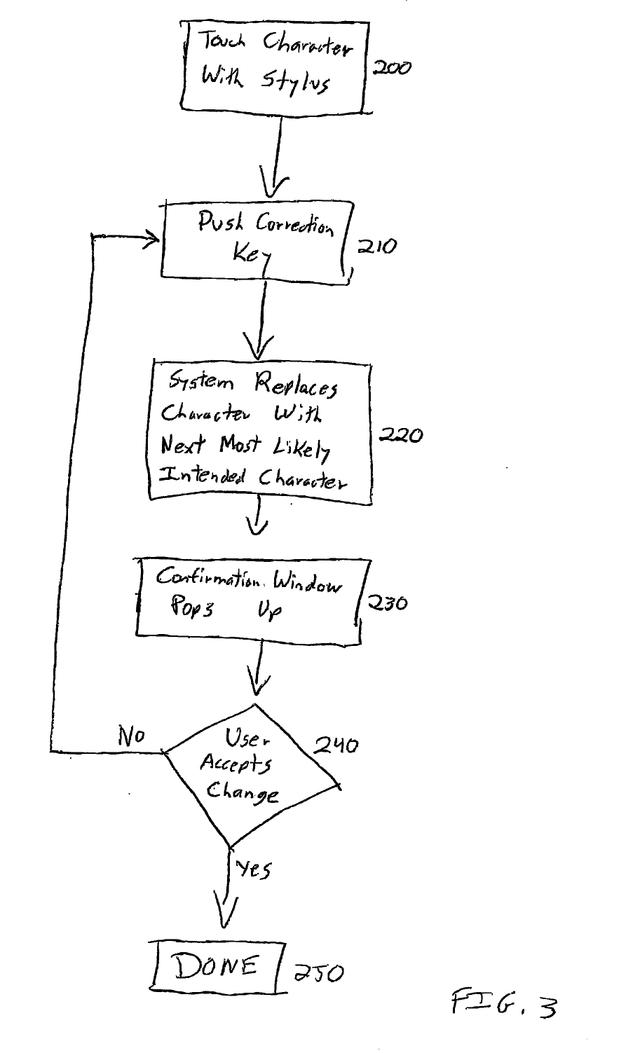

Referring to FIG. 3, a flowchart illustrates a method for automatically correcting an incorrectly recognized or converted character with the next most likely intended character. In preferred embodiments of the present invention, the method disclosed may be implemented as sets of instructions or a software application readable by and preferably stored on the PDA 10, such as in the ROM 40 of the PDA 10. As explained above, in order to correct a single character that has been incorrectly converted, the user first touches the improperly converted letter with the stylus 100 in step 200. In step 210, the user then touches the correction key 150 with the stylus 100, and in step 220, the system automatically replaces the improperly converted letter with the next most likely intended character.

Upon replacing the improperly converted letter, a confirmation window pops up on the display screen 110 in step 230. The confirmation window preferably displays a message, requesting the user to accept or reject the automatically replaced character. As previously mentioned, the keypad 130 includes an “accept change” key 160 and a “next character” key 170. At step 240, the user must decide whether to accept the replacement character by touching the appropriate “accept change” key 160 with the stylus 100. If the user accepts the replacement character, the correction method is concluded at step 250. Otherwise, if the user does not accept the replacement character and touches the “next character” key 170 with the stylus 100 (step not shown), the correction method reverts to step 210, at which the correction key 150 may again be touched with the stylus 100 to display a subsequent next most likely intended character. The user may repeat this iteration until the intended character is displayed.

Importantly, the user may conveniently overwrite the replacement character at any time during the correction method using the overwrite key 180. By touching the overwrite key 180 with the stylus 100, the user may overwrite the incorrectly converted character manually. Details on manually overwriting characters in this manner may be found in U.S. Pat. No. 5,710,831, which is incorporated herein by reference.

Determination of the software application's preliminary next most likely intended characters are based upon a number of factors, such as the user's past tendencies, statistical analyses of typical handwriting conversion errors, and optional manual overwriting of the replacement character. Initially, the software application is programmed to replace a character based upon inherent similarities between handwritten letters resulting in potential conversion errors. These similarities may be determined by studying statistical probabilities of misinterpreting a given character as another character and ranking the next most likely intended characters accordingly.

In addition to statistical analyses, a common sense analysis may be incorporated to help determine characters that are likely to be incorrectly recognized by the PDA 10. For instance, it is inherently obvious that a character such as the letter “V” may easily be misinterpreted as the letter “U”. Accordingly, under the common sense approach, “U” would be a high ranking replacement character for an incorrectly converted “V”. Preferably, determination of the application's preliminary next most likely intended characters involves a comprehensive ranking system based upon both statistical analysis and common sense.

Another significant advantage of the present invention is the ability to learn the personal handwriting idiosyncrasies of particular users. As explained above, the preliminary next most likely intended characters are determined statistically and by common sense. However, the application is capable of learning a user's own handwriting style and producing an individualized ranking system of next most likely intended characters. For example, if the user replaces the letter “U” with the letter “V”, the application will recognize the corrective step based upon the characters involved and adjust the ranking system as discussed below. In this manner, the application can adapt to a particular handwriting style. Once personalized prior handwriting data choices are collected by the application, the next most likely intended characters are first determined according to the individualized ranking system, and then by the preliminary data rankings by default.

The following example is designed to aid in the understanding of the ranking system of the present invention. According to the example, the preliminary next most likely intended characters for the letter “V”, which were determined according to statistical probabilities and common sense, were ranked in the following order: (1) “Y”, (2) “U”, (3) “N”, (4) “W” and (5) “M”. Thus, the first time a new user attempts to replace a “V”, the next most likely intended character will be “Y”, followed by “U”, and then “N”, etc. However, as time passes and the application collects individualized handwriting data, the next most likely intended character rankings will probably change.

Suppose that after an arbitrary amount of time, the user has replaced the character “V” with the character “U” 15 times. In addition “V” has been replaced by “Y” six times and “W” two times. At this stage, the application will have a different order of ranking in which the next most likely intended characters for “V” would be: (1) “U”, (2) “Y”, (3) “W”, (4) “N” and (5) “M”. In this example, “U” is first since it has been used to replace “V” the most times, followed by “Y” and then “W”. Since no other characters have been used to replace “V”, the remaining order is determined by default from the preliminary rankings.

It is believed that a system and a method for automatically correcting an incorrectly converted character with the next most likely intended character of the present invention and many of the attendant advantages will be understood by the foregoing description. It is understood that the specific order or hierarchy of steps in the methods disclosed are examples of preferred embodiments. Based upon design preferences, it is understood that the specific order or hierarchy of steps in the method may be rearranged while remaining within the scope of the present invention. The accompanying method claims present elements of the various steps in a sample order and are not meant to be limited to the specific order or hierarchy presented.

While preferred embodiments and methods have been shown and described, it will be apparent to one of ordinary skill in the art that numerous alterations may be made without departing from the spirit or scope of the invention. Therefore, the scope of the invention is intended to be indicated by the following claims, and all alterations which come within the meaning and range of equivalency of the claims are also intended to be embraced therein.

What is claimed is:

1. A method for correcting a single character of text input onto a display screen of a computing device, the method comprising the steps of:
receiving handwritten text onto the display screen;
converting said handwritten text into a text object;
displaying said text object on the display screen;
receiving an actuation of a correction key;
determining a next most likely intended character to replace an incorrectly converted character; and
replacing said incorrectly converted character with said next most likely intended character.

2. The method as recited in claim 1, further comprising the step of receiving a selection of said incorrectly converted character of said text object on the display screen.

3. The method as recited in claim 1, wherein the steps of determining said next most likely intended character and replacing said incorrectly converted character are repeated until said incorrectly converted character is replaced with an intended character.

4. The method as recited in claim 1, wherein the step of determining said next most likely intended character further comprises the steps of:
ranking a plurality of potential intended characters; and
selecting a highest-ranking character from said ranked plurality of potential intended characters as said next most likely intended character.

5. The method as recited in claim 4, wherein said plurality of potential intended characters are ranked based on statistical probabilities that one character will be incorrectly converted as another character.

6. The method as recited in claim 4, wherein said plurality of potential intended characters are ranked based on common sense that one character will be incorrectly converted as another character.

7. The method as recited in claim 4, wherein said plurality of potential intended characters are ranked based on prior handwriting data choices collected for a user of the computing device.

8. The method as recited in claim 1, wherein said correction key is a soft key on the display screen.

9. The method as recited in claim 1, further comprising the step of, upon replacing said incorrectly converted character with said next most likely intended character, querying whether to accept said replaced next most likely intended character.

10. The method as recited in claim 9, wherein if said replaced next most likely intended character is not accepted, the steps of determining said next most likely intended character and replacing said incorrectly converted character are repeated until said incorrectly converted character is replaced with an intended character.

11. The method as recited in claim 1, further comprising the steps of:
receiving a selection of an overwrite key; and
receiving handwritten text onto the display screen for replacing said incorrectly converted character.

12. A computing device capable of correcting a single character of text input on the computing device, the computing device comprising:
one or more input devices;
a display screen capable of receiving handwritten text and displaying text, wherein said handwritten text is entered using one of said input devices;
a correction key capable of being actuated using one of said input devices; and logic capable of performing the steps of:
receiving handwritten text onto said display screen;
converting said handwritten text into a text object;
displaying said text object on said display screen;
receiving an actuation of said correction key;
determining a next most likely intended character to replace said incorrectly converted character; and
replacing said incorrectly converted character with said next most likely intended character.

13. The computing device as recited in claim 12, further comprising logic capable of receiving a selection of said incorrectly converted character of said text object on said display screen.

14. The computing device as recited in claim 12, wherein the steps of determining said next most likely intended character and replacing said incorrectly converted character are repeated until said incorrectly converted character is replaced with an intended character.

15. The computing device as recited in claim 12, wherein the step of determining said next most likely intended character further comprises the steps of:
ranking a plurality of potential intended characters; and
selecting a highest-ranking character from said ranked plurality of potential intended characters as said next most likely intended character.

16. The computing device as recited in claim 15, wherein said plurality of potential intended characters are ranked based on statistical probabilities that one character will be incorrectly converted as another character.

17. The computing device as recited in claim 15, wherein said plurality of potential intended characters are ranked based on common sense that one character will be incorrectly converted as another character.

18. The computing device as recited in claim 15, wherein said plurality of potential intended characters are ranked based on prior handwriting data choices collected for a user of the computing device.

19. The computing device as recited in claim 12, wherein said correction key is one of: a soft key on said display screen; a hard key on a keyboard, one of said input devices being said keyboard; an icon on said display screen; and a menu on said display screen.

20. The computing device as recited in claim 12, further comprising:
an overwrite key capable of being actuated using one of said input devices; and
logic capable of receiving handwritten text onto the display screen for replacing said incorrectly converted character upon actuation of said overwrite key.

21. The computing device as recited in claim 12, wherein said handwritten text is entered and said correction key is capable of being actuated using the same one of said input devices.

22. The computing device as recited in claim 21, wherein the computing device is a personal digital assistant, and said same one of said input devices is a stylus.

23. The computing device as recited in claim 12, wherein said handwritten text is entered and said correction key is capable of being actuated using different ones of said input devices.

24. A storage medium capable of being read by a computing device and having instructions encoded thereon for causing the computing device to perform a method for correcting a single character of text input onto a display screen of the computing device, the method comprising the steps of:
receiving handwritten text onto the display screen;
converting said handwritten text into a text object;
displaying said text object on the display screen;
receiving an actuation of a correction key;
determining a next most likely intended character to replace said incorrectly converted character; and
replacing said incorrectly converted character with said next most likely intended character.

25. The storage medium as recited in claim 24, the method further comprising the step of receiving a selection of an incorrectly converted character of said text object on the display screen.

26. The storage medium as recited in claim 24, wherein the steps of determining said next most likely intended character and replacing said incorrectly converted character are repeated until said incorrectly converted character is replaced with an intended character.

27. The storage medium as recited in claim 24, wherein the step of determining said next most likely intended character further comprises the steps of:
ranking a plurality of potential intended characters; and
selecting a highest-ranking character from said ranked plurality of potential intended characters as said next most likely intended character.

28. The storage medium as recited in claim 27, wherein said plurality of potential intended characters are ranked based on statistical probabilities that one character will be incorrectly converted as another character.

29. The storage medium as recited in claim 27, wherein said plurality of potential intended characters are ranked based on common sense that one character will be incorrectly converted as another character.

30. The storage medium as recited in claim 27, wherein said plurality of potential intended characters are ranked based on prior handwriting data choices collected for a user of the computing device.

31. The storage medium as recited in claim 24, wherein said correction key is a soft key on the display screen.
